(19) United States
(12) Patent Application Publication
(10) Pub. No.: US 2016/0224907 A1
(43) Pub. Date: Aug. 4, 2016

(54) JOINT MEETING SCHEDULING AND CARPOOLING

(71) Applicant: INTERNATIONAL BUSINESS MACHINES CORPORATION, Armonk, NY (US)

(72) Inventors: Randall L. Cogill, Malahide (IE); Sajja Surya Shravan Kumar, Mulhuddart (IE); Joe Naoum-Sawaya, Mulhuddart (IE); Robert Shorten, Mulhuddart (IE); Fabian R. Wirth, Dunboyne (IE); Jia Y. Yu, Montreal (CA)

(21) Appl. No.: 14/746,521

(22) Filed: Jun. 22, 2015

Related U.S. Application Data
(63) Continuation of application No. 14/612,591, filed on Feb. 3, 2015.

(51) Int. Cl. G06Q 10/02; G06Q 10/10

(52) U.S. Cl. CPC G06Q 10/02; G06Q 10/1095

(57) ABSTRACT

Methods and systems for scheduling include receiving a plurality of scheduling requests for events, where each of the scheduling requests includes a list of invited individuals. An optimization problem is solved based on the set of scheduling requests, a set of available times for respective invited individuals, location information for the respective invited individuals, a set of possible locations, and a set of available vehicles. Times and locations are scheduled responsive to respective scheduling requests based on the solution to the optimization problem and invited individuals are assigned to vehicles, if said invited individuals are in locations other than a respective scheduled location, to provide transportation for each invited individual to and from the scheduled location.

### CROSS REFERENCE TO RELATED APPLICATIONS

This application is a Continuation application of co-pending U.S. patent application Ser. No. 14/612,591, filed on Feb. 3, 2015, incorporated herein by reference in its entirety.

### BACKGROUND

1. Technical Field

The present invention relates to resource optimization and, more particularly, to scheduling meetings to minimize use of transportation resources.

2. Description of the Related Art

Conventional scheduling for meetings is performed on an ad hoc basis, with individual meetings being scheduled one at a time. This results in inefficient use of resources, as those who schedule meetings early will not be able to take into account the needs of those who come after. One particular instance of this inefficiency comes when meetings involve people across multiple worksites. In such cases, a company can provide a car service to move employees when their meetings are in a different building.

One exemplary setting where individuals often travel among buildings is in a large industrial or university campus. While individuals could use their own vehicles or use a regularly scheduled shuttle to travel between buildings, carsharing services offer advantages that other alternatives cannot. However, ensuring that there is a sufficient number of vehicles available to meet demand can be difficult. In conventional car sharing systems, vehicles are reserved as the need to use them arises, but this leads to significant inefficiencies.

### SUMMARY

A method for scheduling includes receiving a plurality of scheduling requests for events, said scheduling requests comprising a list of invited individuals. An optimization problem is solved based on the set of scheduling requests, a set of available times for respective invited individuals, location information for the respective invited individuals, a set of possible locations, and a set of available vehicles. Times and locations are scheduled responsive to respective scheduling requests. Invited individuals are assigned to vehicles based on the solution to the optimization problem, if said invited individuals are in locations other than a respective scheduled location, to provide transportation for each invited individual to and from the scheduled location.

A system for scheduling includes a memory comprising a plurality of scheduling requests for events, each of said scheduling requests comprising a list of invited individuals. A scheduling module comprising a processor is configured to solve an optimization problem based on the plurality of scheduling requests, a set of available times for respective invited individuals, location information for the respective invited individuals, a set of possible locations, and a set of available vehicles, to schedule times and locations responsive to respective scheduling requests based on the solution to the optimization problem, and to assign invited individuals to vehicles, if said invited individuals are in locations other than a respective scheduled location, to provide transportation for each invited individual to and from the scheduled location.

These and other features and advantages will become apparent from the following detailed description of illustrative embodiments thereof, which is to be read in connection with the accompanying drawings.

### BRIEF DESCRIPTION OF THE SEVERAL VIEWS OF THE DRAWINGS

The disclosure will provide details in the following description of preferred embodiments with reference to the following figures wherein:

FIG. 1 is a diagram of an exemplary meeting schedule in accordance with the present principles;

FIG. 2 is a diagram of an exemplary meeting schedule in accordance with the present principles;

FIG. 3 is a block/flow diagram of a method for scheduling events and vehicles in accordance with the present principles;

FIG. 4 is a block diagram of a scheduling system in accordance with the present principles; and

FIG. 5 is a diagram of an exemplary arrangement in a workplace for a meeting request in accordance with the present principles.

### DETAILED DESCRIPTION

Embodiments of the present principles optimize the utilization of shared resources by exploiting flexibility in when and where resources are to be used. In the example of carsharing for meetings, meetings can be scheduled and located in a way that maximizes the sharing of vehicles, ensuring that a relatively small fleet of vehicles can serve the demands of a large population of users. In simulations, the present embodiments have shown that needs can be met using approximately 34% fewer vehicles compared to conventional carsharing services. This allows the use of a relatively small fleet of vehicles to keep quality of service high while keeping operational costs low. To accomplish this, the present embodiments schedule the time and location of meetings and vehicles jointly. This stands in contrast to schemes which first schedule meetings and then subsequently reserve vehicles. It should be understood that, while the present embodiments are described with particular attention to scheduling meetings and managing ridesharing services, they can be applied to any scheduling task having shared resources.

Notably, the present embodiments create and then exploit additional flexibility in the scheduling requests themselves. In a conventional approach, the details of the requests might be completely specified at the outset. Such a system would then attempt to optimally satisfy the requests with a collection of limited resources. In contrast, the present embodiments avoid specifying certain details of the requests (specifically, location and time) to allow for greater flexibility in scheduling. The resources can then be optimally assigned.

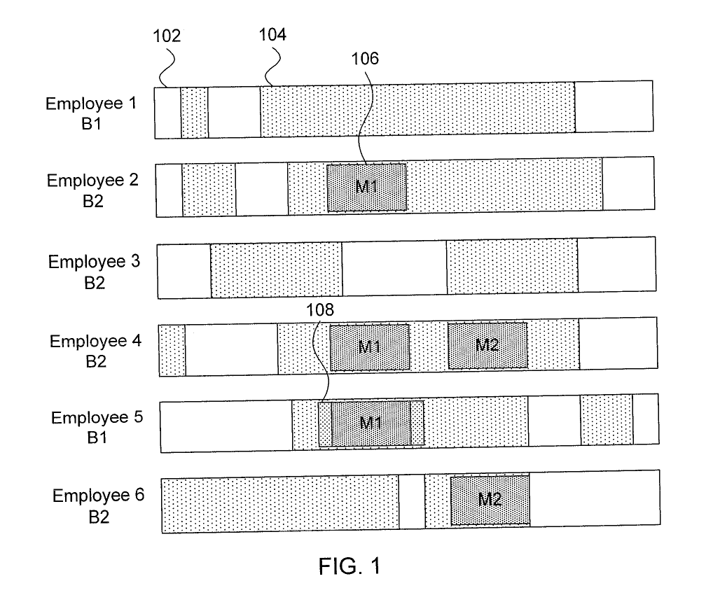

Referring now to the drawings in which like numerals represent the same or similar elements and initially to FIG. 1, an exemplary schedule of available times for six employees is shown. A timeline 102 for each employee has an office in one of two buildings, labeled B1 or B2. The available times are shown by boxes 104. In this initial example, only two meetings 106 are allocated, designated M1 and M2. In cases where an employee 102 must travel to the other building for the meeting 106, transit time 108 is also allocated to account for travel to and from the other building. In this simple example, there are no conflicts between meetings, such that only one car is needed.

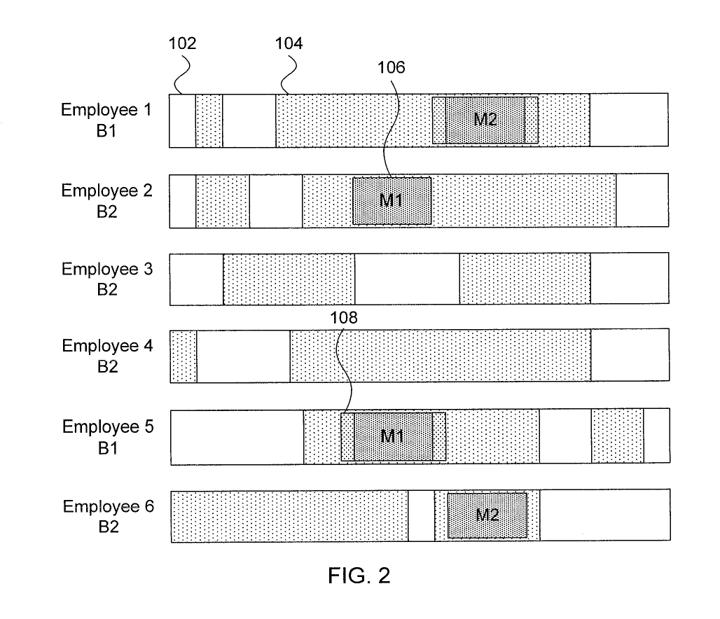

Referring now to FIG. 2, a second exemplary schedule is shown. In this case, three meetings are scheduled, and three cars are needed. In this case, the travel time 108 for M1 overlaps with the travel time 108 for M2, necessitating the use for two separate cars. This could have been avoided by considering carsharing needs at the time of scheduling the meetings as described below.

To begin with, the present description makes certain assumptions. In particular, all meeting requests are given at the start of the planning horizon, all meeting attendees return to their offices following a meeting, a car used to travel to meetings is unavailable to other groups until its return trip is completed, passengers travel to and return from meetings together, and groups travel from a given office location to the meeting location (i.e., no pickups or drop-offs en route). It should be understood that these assumptions are listed solely for the sake of discussion and should not be construed as limiting, as a given implementation can lack one or more of the assumptions and can have other assumptions in place instead.

A set of employees, each with respective available times and respective office locations, as well as travel time between building locations, is used as input. Meetings, having a specified duration and list of attendees, are provided along with the passenger capacity of each vehicle. For each meeting, the present embodiments determine the building where the meeting will be held, the starting time of the meeting, and the assignment of individuals to vehicles. These decisions can be made to optimize various objectives, including total employee-time spent traveling, the number of vehicles needed to serve the meetings, total vehicle-time spent traveling, the maximum travel time needed by any one employee, and the maximum load factor on any one building (i.e., how many meetings and employees per meeting a building can host).

To accomplish this, meetings 106 are assigned to “bins” that have the same start time and location and, at least roughly, the same end time. Cars are used at each office location to serve bins, such that individuals traveling to different meetings at the same location can travel together.

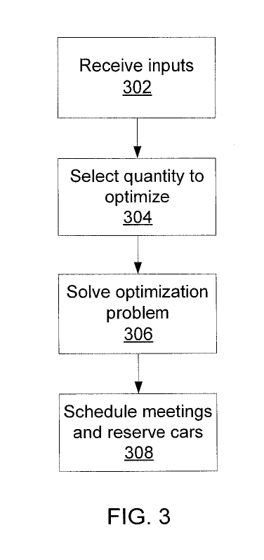

Referring now to FIG. 3, a method of scheduling is shown. Block 302 accepts the inputs described above describing the setting and the particular meetings to be scheduled. Block 304 selects a quantity to optimize based on the input factors. The quantity to optimize can be, for example, total employee-time spent traveling, maximum load factor on any one building, maximum travel time for any one employee, total cars needed over all bins, total number of bins needed, and total vehicle-time spent traveling. Block 306 solves the respective optimization problem subject to a set of constraints, and block 308 uses the solution to the optimization problem to schedule meetings and cars. Using off-the-shelf solvers, simulated instances having 100 individuals, 20 meetings, and 20 buildings took roughly 50 seconds to run. Scheduling can be performed in batches throughout the day to determine schedules before the instance size becomes unmanageable.

A user who wants to schedule a new meeting would, for example, create a new meeting request in their calendar application by specifying the desired day, duration, and attendees for the meeting, but without specifying the meeting location and time. This information is then provided as input in block 302.

The system then gathers meeting requests and performs batch scheduling of meetings on a periodic basis. For example, the system could process incoming meeting requests every three hours. The system has access to each individual's calendar and knows each individual's office location. When scheduling and locating meetings in blocks 306 and 308, the system selects a meeting time and location so that all attendees have sufficient time to travel to, attend, and return from the meeting. If there is no feasible meeting time on the desired day, the soonest available day with a feasible meeting time is selected. If individuals must travel to the meeting, they are assigned to a car in block 308, which they can share with other individuals making the same trip. Upon scheduling the meeting, block 308 sends an invitation to the meeting that includes the meeting time, meeting location, and car assignment (if needed). Upon receiving the invitation, invited attendees can accept or decline the invitation. As individuals accept or decline the invitation, the initiator of the meeting is sent a message stating as such. Based on the responses from invitees, the initiator of the meeting can cancel or reschedule the meeting, which would begin the process again in block 304.

Solving the optimization problem in block 306 uses a particular optimization function and a set of constraints. To achieve the optimal result, the solutions to the function often identify and exploit non-obvious overlaps in meeting requests. For example, the solutions can schedule distinct meetings at the same location and time, so that individuals traveling to these different meetings from the same location can share a car. The following quantities are used to describe the different possibilities:

tᵢ: Starting time of meeting i.

xᵢⱼₗ: Binary variable indicating if meeting i is in individual l's time interval j.

yᵢₖ: Binary variable indicating if meeting i is in location k.

z_{ii′}: Binary variable indicating if meeting i precedes meeting i′.

wᵢₘ: Binary variable indicating if meeting i is assigned to bin m.

τₘ: The start time of meetings in bin m.

ωₘ: The end times of meetings in bin m.

c_{bm}: The number of cars at building b to serve meetings in bin m.

vₘₖ: Binary variable indicating if bin m travels to location k.

sₗⱼ: Starting time of available interval j for individual l.

eₗⱼ: Ending time of available interval j for individual l.

rₗₖ: Time needed for individual l to travel to location k.

dᵢ: The duration of meeting i.

γ_{bi}: The number of individuals in building b attending meeting i.

κ: The capacity of each car.

A first constraint that can be used is that the meetings and travel times fall within a feasible interval. This constraint can be characterized, for each individual l and meeting i attended by l, as:

$${\sum }_{j} {s}_{lj} {x}_{ijl} + {\sum }_{k} {r}_{lk} {y}_{ik} \leq {t}_{i}$$

$${t}_{i} + {d}_{i} + {\sum }_{k} {r}_{lk} {y}_{ik} \leq {\sum }_{j} {e}_{lj} {x}_{ijl}$$

A second constraint that can be used is that an individual's meetings and travel times cannot overlap. For an individual l attending two meetings, i and i′, this constraint can be characterized as:

$${t}_{i} + {d}_{i} + {\sum }_{k} {r}_{lk} {y}_{ik} \leq {t}_{{i}^{′}} - {\sum }_{k} {r}_{lk} {y}_{{i}^{′} k} + 24 ( 1 - {z}_{{ii}^{′}} )$$

$${t}_{i}^{′} + {d}_{i}^{′} + {\sum }_{k} {r}_{lk} {y}_{{i}^{′} k} \leq {t}_{i} - {\sum }_{k} {r}_{lk} {y}_{ik} + 24 {z}_{{ii}^{′}}$$

One of these constraints can be enforced a priori if a precedence is required.

A third constraint can be that every meeting is scheduled in one feasible interval. This can be expressed, for all meetings i and individuals l, as:

$${\sum }_{j} {x}_{ijl} = 1$$

A fourth constraint can be that every meeting is scheduled in only one location. This can be expressed, for all meetings i, as:

$${\sum }_{k} {y}_{ik} = 1$$

A fifth constraint can be that meetings assigned to the same bin have the same start time. This can be expressed, for each bin m and meeting i, as:

τₘ−24(1−wᵢₘ)≦tᵢ+ε

τₘ+24(1−wᵢₘ)≧tᵢ−ε

where ε is an allowable variation around the starting time that allows some relaxation of the constraint that all meetings in the same bin start and end and precisely the same times.

A sixth constraint can be that meetings assigned to the same bin have the same end time. This can be expressed, for each bin m and meeting i, as:

ωₘ−24(1−wᵢₘ)≦tᵢ+dᵢ+ε

ωₘ+24(1−wᵢₘ)≧tᵢ+dᵢ−ε

A seventh constraint can be that every meeting is assigned to only one bin. This can be expressed, for all meetings i, as:

$${\sum }_{m} {w}_{im} = 1$$

An eighth constraint can be that every bin travels to one location. This can be expressed, for all bins m, as:

$${\sum }_{k} {v}_{mk} = 1$$

A ninth constraint can be that meetings assigned to the same bin have the same location. This can be expressed, for each bin m, meeting i, and location k, as:

vₘₖ≦yᵢₖ+(1−wᵢₘ)

A tenth constraint can be that each car cannot be filled beyond its capacity. This can be expressed, for each office location b and bin m, as:

$${\sum }_{i} {γ}_{bi} {w}_{im} \leq κ {c}_{bm}$$

A first possible objective function optimizes the total employee-time spent traveling and can be characterized as:

$$minimize \text{:} 2 {\sum }_{i} {\sum }_{k} {\sum }_{l ∈ {M}_{i}} {r}_{lk} {y}_{ik}$$

where Mᵢ is the set of employees attending the meeting i.

A second possible objective function optimizes the load factor on any one building and can be characterized as:

$$minimize \text{:} α$$

$$subject to \text{:} {c}_{k} {\sum }_{i} {y}_{ik} \leq α ∀ k$$

where cₖ is the reciprocal of the number of meeting rooms in building k.

A third possible objective function optimizes the maximum travel time needed by any one employee and can be characterized as:

$$minimize \text{:} α$$

$$subject to \text{:} {\sum }_{k} {r}_{lk} {y}_{ik} \leq α ∀ i , l ∈ {M}_{i}$$

A fourth possible objective function minimizes the total number of cars needed over all bins and can be characterized as:

$$minimize \text{:} {\sum }_{m} {\sum }_{b} {c}_{bm}$$

A fifth possible objective function minimizes the total number of bins needed and can be characterized as:

$$minimize \text{:} {\sum }_{m} {β}_{m}$$

$$subject to \text{:} {β}_{m} \geq {w}_{im} ∀ i , m$$

Note that the variable βₘ indicates if at least one meeting is assigned to bin m. For example, a model might allow for up to ten bins, with the aim of using as few as possible. Note that each βₘ will always take an integer value in an optimal solution. However, when formulating the optimization problem, each βₘ can be equivalently treated as a continuous variable. This reduces the number of integer variables in the problem formulation, potentially reducing the computation required to obtain an optimal solution.

A sixth possible objective function minimizes the total vehicle-time spent traveling and can be characterized as:

$$minimize \text{:} {\sum }_{b} {\sum }_{m} {θ}_{bm}$$

$$subject to \text{:} {θ}_{bm} \geq {c}_{bm} {r}_{bk} - K ( 1 - {v}_{mk} ) ∀ m , b , k$$

$$subject to \text{:} {θ}_{bm} \geq 0 ∀ m , b$$

where K is a large constant, selected so that the constraint is not enforced if bin m does not travel to location k.

The present invention can be a system, a method, and/or a computer program product. The computer program product can include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention can be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions can also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions can also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams can represent a module, segment, or portion of instructions, which comprises one or more executable instructions for implementing the specified logical function(s). In some alternative implementations, the functions noted in the block can occur out of the order noted in the figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

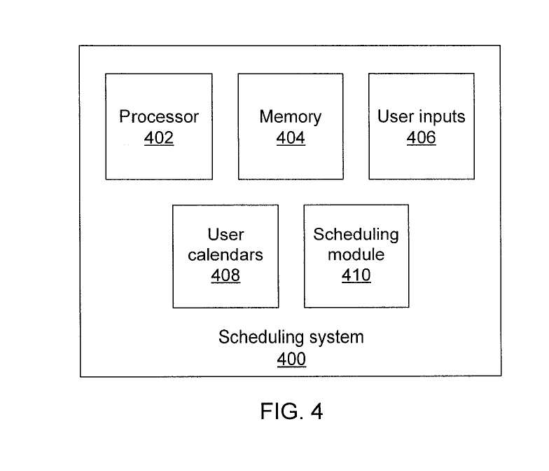

Referring now to FIG. 4, a scheduling system 400 is shown. The system 400 includes a processor 402 and a memory 404. The memory 404 stores user inputs 406 and user calendars 408. A scheduling module 410 uses processor 402 to create meeting schedules based on the user inputs 406 and the user calendars 408, as well as additional contextual information stored in memory 404, such as vehicle capacity information and which users occupy which buildings.

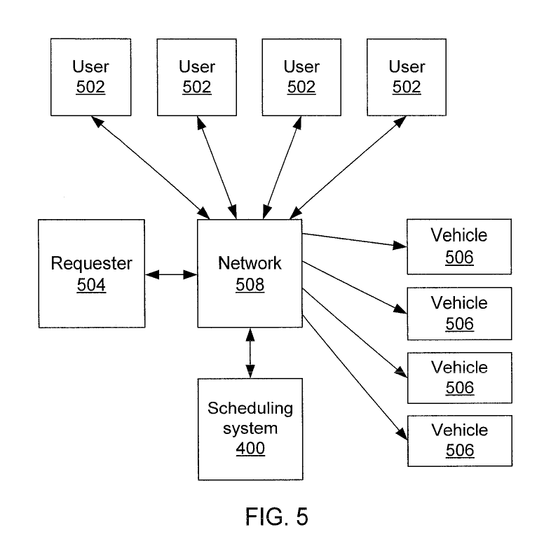

Referring now to FIG. 5, an exemplary arrangement in a workplace is shown. A set of users 502, each interacting with a respective device that may include, for example, a desktop computer, a laptop, or a smart phone, maintains an up-to-date calendar of their available times in scheduling system 400. A requester 504 creates a meeting request using the scheduling system 400 using another such device, the request including a date and list of invitees. The users 502 and requester 504 communicate with the scheduling system 400 through a network 508 that may include one or more intervening devices and any appropriate networking medium.

The scheduling system 400 stores the calendar and request information in a memory 404 uses a processor 402 to consider the request as well as any other requests that have been entered, the available times for the invitees of each request, and the available vehicles 506, to solve an optimization problem as described above and to generate a schedule that provides a time and location for each requested meeting based on the optimal solution. The scheduling system informs the users 502, the requester 506, and the vehicles 506, so that each user 502 knows where to catch an appropriate vehicle 506 and so that each vehicle 506 has a list of what users 502 are riding and to what location. The scheduling system 400 may communicate with the users 502 and the requester 504 through the network 508. The scheduling system 400 may further communicate with the vehicles 506 using network 508 if network 508 includes wireless capability, or alternatively the scheduling system 400 may communicate with the vehicles 506 by any appropriate alternative means, including for example two-way radio.

Having described preferred embodiments of a system and method for joint meeting scheduling and carpooling (which are intended to be illustrative and not limiting), it is noted that modifications and variations can be made by persons skilled in the art in light of the above teachings. It is therefore to be understood that changes can be made in the particular embodiments disclosed which are within the scope of the invention as outlined by the appended claims. Having thus described aspects of the invention, with the details and particularity required by the patent laws, what is claimed and desired protected by Letters Patent is set forth in the appended claims.

1. A method for scheduling, comprising:
receiving a plurality of scheduling requests for events, said scheduling requests comprising a list of invited individuals;
solving an optimization problem using a processor based on the set of scheduling requests, a set of available times for respective invited individuals, location information for the respective invited individuals, a set of possible locations, and a set of available vehicles;
scheduling times and locations responsive to respective scheduling requests; and
assigning invited individuals to vehicles based on the solution to the optimization problem, if said invited individuals are in locations other than a respective scheduled location, to provide transportation for each invited individual to and from the scheduled location.

2. The method of claim 1, wherein the plurality of scheduling requests do not specify an event time or location.

3. The method of claim 1, wherein the plurality of scheduling requests each consist of the list of invited individuals; a requested day, and a requested duration.

4. The method of claim 1, further comprising accessing calendars for invited individuals to determine available times for the respective invited individuals.

5. The method of claim 1, wherein the optimization problem minimizes a number of vehicles needed to transport every individual to a respective scheduled location.

6. The method of claim 5, wherein individuals having a shared location and traveling to a same location are assigned to a same vehicle.

7. The method of claim 1, wherein the optimization problem minimizes the total time individuals spend traveling.

8. The method of claim 1, wherein the optimization problem minimizes the maximum travel time needed by any one individual.

9. The method of claim 1, wherein the optimization problem allocates events to bins, where all events in a given bin have about a same start and end time and each bin represents travel to a single location.
